(19) United States
(12) Patent Application Publication
(10) Pub. No.: US 2026/0154638 A1
(43) Pub. Date: Jun. 4, 2026

(54) INFORMATION RECOMMENDATION METHOD AND RELATED APPARATUS

(71) Applicant: MASHANG CONSUMER FINANCE CO., LTD., Chongqing (CN)

(72) Inventors: Hongyu ZHAO, Chongqing (CN); Kexin LI, Chongqing (CN)

(21) Appl. No.: 19/093,182

(22) Filed: Mar. 27, 2025

(30) Foreign Application Priority Data
Dec. 4, 2024 (CN) 202411775024.4

(51) Int. Cl. G06Q 10/0631; G06Q 10/0633

(52) U.S. Cl. CPC G06Q 10/06316; G06Q 10/0633

(57) ABSTRACT

In an information recommendation method, a service processing indicator score of each service work order of a first set of service work orders is determined. A second set of service work orders are selected from the first set of service work orders with service processing indicator scores satisfy a preset value. First data of each of the second set of service work orders are determined based on service work order information in each of the second set of service work orders. Second data of each of the second set of service work orders are determined based on service processing result in each of the second set of service work orders. A training set is generated based on the first data and the second data. An initial information recommendation model is trained based on the training set to obtain an information recommendation model. A processing sequence of each to-be-processed service work order is obtained based on the information recommendation model. The processing sequence of each to-be-processed service work order is displayed.

### RELATED APPLICATION

The present application claims priority to Chinese Patent Application No. 202411775024.4 filed on Dec. 4, 2024, which is hereby incorporated by reference in its entirety.

### FIELD OF THE TECHNOLOGY

This disclosure relates to the field of electric digital data processing technologies, including to an information recommendation model training method, an information display processing method, and a related apparatus.

### BACKGROUND OF THE DISCLOSURE

A client service order issuing system can be provided with a work order recommendation model configured to recommend an adaptive service work order based on personal work feature data of a work order operator. An input side of the model is basic information of a service work order of the work order operator and the personal work feature data of the work order operator. A matching degree is outputted. A higher matching degree indicates that a current to-be-allocated service work order is more suitable for a work order operator currently processing the order. After the work order allocation stage, the work order operator performs service processing based on a recommended service work order. However, work orders recommended by this type of models still need the work order operator to select how to process the work orders. How to further improve intelligence and functionality of work order allocation becomes a problem.

### SUMMARY

In view of this, this disclosure provides an information recommendation model training method, an information display processing method, and a related apparatus. Service work order data of which a service processing indicator score satisfies a preset processing indicator score is selected and used as a training sample, so that the information recommendation model can be trained by using a more effective training sample. This can help ensure that the information recommendation model recommends adaptive information for different execution subjects, and facilitates improvement of intelligence and functionality of service work order allocation.

In an aspect of this disclosure an information recommendation method is provided. In the method, a service processing indicator score of each service work order of a first set of service work orders is determined. A second set of service work orders is selected from the first set of service work orders. The service work orders of the second set have service processing indicator scores that satisfy a preset value. First data of each of the second set of service work orders are determined based on service work order information in each of the second set of service work orders. Second data of each of the second set of service work orders are determined based on a service processing result in each of the second set of service work orders. A training set is generated based on the first data and the second data. An initial information recommendation model is trained based on the training set to obtain an information recommendation model. A processing sequence of each to-be-processed service work order is obtained based on the information recommendation model. The processing sequence of each to-be-processed service work order is displayed.

In an aspect of this disclosure, an information display processing method is provided. In the method, a first message is received from a server, the first message being configured for representing a processing sequence of each to-be-processed service work order of a customer service user, a representation manner for the processing sequence including a work order sequence, the first message being determined by using an information recommendation model. The information recommendation model is determined by the server in the following manner: determining a service processing indicator score of each piece of first service work order data; selecting first service work order data of which service processing indicator score satisfies a preset processing indicator score, as second service work order data; determining first data of each training sample based on each piece of service work order information in each piece of second service work order data; determining second data of each training sample based on each service processing result in each piece of second service work order data; generating a training set based on the first data of each training sample and the second data of each training sample; and training an original model by using the training set, to obtain the information recommendation model. Further, the processing sequence of each to-be-processed service work order is displayed.

In an aspect of this disclosure an information recommendation model training apparatus including processing circuitry is provided. The processing circuitry is configured to determine a service processing indicator score of each service work order of a first set of service work orders. The processing circuitry is configured to select a second set of service work orders from the first set of service work orders. The service work orders of the second set have service processing indicator scores that satisfy a preset value. The processing circuitry is configured to determine first data of each of the second set of service work orders based on service work order information in each of the second set of service work orders. The processing circuitry is configured to determine second data of each of the second set of service work orders based on service processing result in each of the second set of service work orders. The processing circuitry is configured to generate a training set based on the first data and the second data. The processing circuitry is configured to train an initial information recommendation model based on the training set to obtain an information recommendation model. The processing circuitry is configured to obtain a processing sequence of each to-be-processed service work order based on the information recommendation model. The processing circuitry is configured to display the processing sequence of each to-be-processed service work order.

An aspect of this disclosure provides a non-transitory computer readable storage medium. The non-transitory computer-readable storage medium stores a computer program which when executed by a processor, causes the processor to perform any of the methods according to this disclosure.

According to aspects of the foregoing information recommendation model training method, information display processing method, and related apparatus, first, the service processing indicator score of each piece of first service work order data is determined. The first service work order data of which service processing indicator score satisfies the preset processing indicator score is selected, as the second service work order data. The first data of each training sample is determined based on each piece of service work order information in each piece of second service work order data. The second data of each training sample is determined based on each service processing result in each piece of second service work order data. The training set is generated based on the first data of each training sample and the second data of each training sample. The original model (or initial model) is trained by using the training set, to obtain the information recommendation model. The information recommendation model can be trained by using a more effective training sample, to ensure that the information recommendation model can recommend adaptive information for different execution subjects, and facilitate improvement of intelligence and functionality of service work order allocation.

### BRIEF DESCRIPTION OF THE DRAWINGS

The following briefly describes the accompanying drawings for describing aspects of this disclosure. The accompanying drawings in the following description show merely some aspects of this disclosure, and a person of ordinary skill in the art may still derive other drawings from these accompanying drawings.

FIG. 1 is a system architecture diagram of an information recommendation model training method according to an aspect of this disclosure.

FIG. 2 is a schematic flowchart of an information recommendation model training method according to an aspect of this disclosure.

FIG. 3 is a schematic diagram of a structure of an information recommendation model according to an aspect of this disclosure.

FIG. 4 is a schematic flowchart of an information display processing method according to an aspect of this disclosure.

FIG. 5 is a schematic diagram of an information display interface according to an aspect of this disclosure.

FIG. 6 is a schematic diagram of a structure of a server according to an aspect of this disclosure.

FIG. 7 is a schematic diagram of a structure of a customer service user device according to an aspect of this disclosure.

FIG. 8 is a block diagram of formation of functional units of an information recommendation model training apparatus according to an aspect of this disclosure.

FIG. 9 is a block diagram of formation of functional units of an information display processing apparatus according to an aspect of this disclosure.

### DETAILED DESCRIPTION

To enable a person skilled in the art to better understand the solutions of this disclosure, the following describes examples of technical solutions of this disclosure with reference to the accompanying drawings. The described aspects are merely some rather than all of aspects of this disclosure. Other aspects shall fall within the protection scope of this disclosure.

Examples of terms involved in the aspects of the disclosure are briefly introduced. The descriptions of the terms are provided as examples only and are not intended to limit the scope of the disclosure.

The terms “first” and “second”, and the like in the specification, claims, and accompanying drawings of aspects of this disclosure are used for distinguishing between different objects, and are not used for describing a specific sequence. In addition, the terms “include”, “have”, and any variant thereof are intended to cover a non-exclusive inclusion. For example, a process, method, system, product, or device that includes a series of operations or units is not limited to the listed operations or modules, but in some aspects further includes an operation or unit that is not listed, or in some aspects further includes another inherent operation or unit of the process, method, product, or device.

The term “and/or” used herein describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects. In addition, “a plurality of” in aspects of this disclosure means two or more.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

“Connection” in aspects of this disclosure refers to various connection manners such as direct connection or indirect connection, to implement communication between devices. This is not limited in aspects of this disclosure.

Aspect mentioned in the specification means that particular features, structures, or characteristics described with reference to the aspect may be included in at least one aspect of this disclosure. The occurrence of the phrase at various positions in the specification does not necessarily refer to the same aspect, nor is an independent or alternative aspect mutually exclusive to other aspects. It is explicitly and implicitly understood by a person skilled in the art that aspects described in the specification may be combined with another aspect.

Loan borrower: The loan borrower is briefly referred to as a borrower or a client, and is an enterprise, institution, or an individual who borrows money from a lender by using their own credit or property as collateral or by using a third party as collateral. In aspects of this disclosure, the loan borrower may be understood as a to-be-repaid party.

Loan contact: The loan contact is briefly referred to as a contact, and helps contact a borrower when a loan institution cannot contact the borrower. The contact does not take responsibility for loans. In aspects of this disclosure, target information of a to-be-repaid party may be contact information of the loan contact, or may be contact information of a loan borrower.

Lender: The lender refers to a person or a financial institution that uses credit money or owned money to lend loans to borrowers in a loan activity, and generally refers to a commercial bank, a financial institution, or a central bank.

Agent: The agent refers to a loan collection personnel in a financial institution. In aspects of this disclosure, a loan collection party may be understood as an agent or a group formed by agents, that is, a customer service user.

Collection succeeds: After communication, a client makes repayment.

Collection fails: After communication, a client does not make repayment, and continues to be overdue.

Promise to pay (PTP): Through phone collection, a client promises to repay a specific amount of debt within a period, which is referred to as the promise to pay, and refers to a quantity of clients who promise to pay herein.

Keep promise (KP): It is a quantity of clients who actually repay after the clients promised to pay (PTP).

Aspects of this disclosure may be applied to the following scenarios, including but not limited to: a processing system that is deployed on an electronic device and that is based on a neural network, large-scale information recommendation (for example, functions such as recalling a target and ranking from large-scale candidates) speech signal processing natural language processing, a recommendation system, and the like.

The electronic device in aspects of this disclosure may be a portable electronic device that further includes other functions such as a personal digital assistant and/or a music player function, such as a mobile phone, a tablet computer, or a wearable electronic device (for example, a smart watch) having a wireless communication function. An aspect of the portable electronic device includes, but is not limited to, a portable electronic device running an IOS system, an Android system, a Microsoft system, or another operating system. The portable electronic device may alternatively be another portable electronic device such as a laptop. In some other aspects, the electronic device may alternatively not be a portable electronic device, but is a desktop computer, a server, or the like.

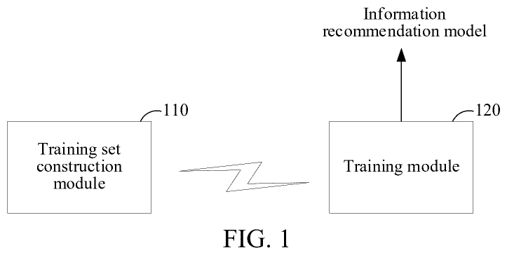

For ease of understanding, FIG. 1 is a system architecture diagram of an information recommendation model training method according to an aspect of this disclosure. As shown in FIG. 1, a training set construction module 110 and a training module 120 are included.

The training set construction module 110 is configured to evaluate each piece of service work order data, and select service work order data of which service processing indicator satisfies a preset processing indicator score to construct a training set. For ease of distinguishing, in this aspect of this disclosure, service work order data before selection is referred to as first service work order data, and the selected service work order data is referred to as second service work order data. The service work order data may include execution subject information, execution object information, execution process information, service basic information, and the like. The service work order data may be evaluated based on the foregoing information, to obtain a service processing indicator score of each piece of service work order data. The score may reflect a conversion status, a communication status, a violation status, a complaint status, and the like of the service work order data. Details are not described herein.

A large amount of data can be processed by using the training set construction module 110, to select data more suitable as the training set, thereby improving accuracy of subsequent training for an information recommendation model, and further improving intelligence and functionality of service work order allocation.

The training module 120 is configured with a cross entropy loss function and/or a sorting loss function. Input data for training an original model and label data for training the original model are determined by using service work order information of the training set, output of the original model is compared with the label data, and reverse iteration is performed on the original model in combination with the cross entropy loss function and/or the sorting loss function until the original model converges, to obtain the information recommendation model.

By using the training module 120, the original model may be updated by using the two loss functions. In a case that the sorting loss function is introduced, it can be ensured that the information recommendation model can recommend adaptive information for different execution subjects. In addition, a time dimension is further introduced in the adaptation. This facilitates improvement of intelligence and functionality of service work order allocation.

For ease of understanding, a case in which a service work order is a collection service is used as an example for description. When a borrower is overdue and does not make repayment, collection needs to be performed. An automatic distribution system distributes, to a customer service user device, target information of a to-be-repaid party whose collection needs to be performed. A customer service user makes a call to a corresponding user device by using the customer service user device to complete collection of the to-be-repaid party. The information recommendation model may be installed in the automatic allocation system. The information recommendation model may recommend, for different customer service users, related information of a to-be-repaid party that has a higher probability of repayment after being collected by a current customer service user. In addition, the automatic allocation system may sort the target information of the to-be-repaid party in descending order of the probability of repayment. The customer service user may make a call based on the sorting, thereby improving collection efficiency of the customer service user.

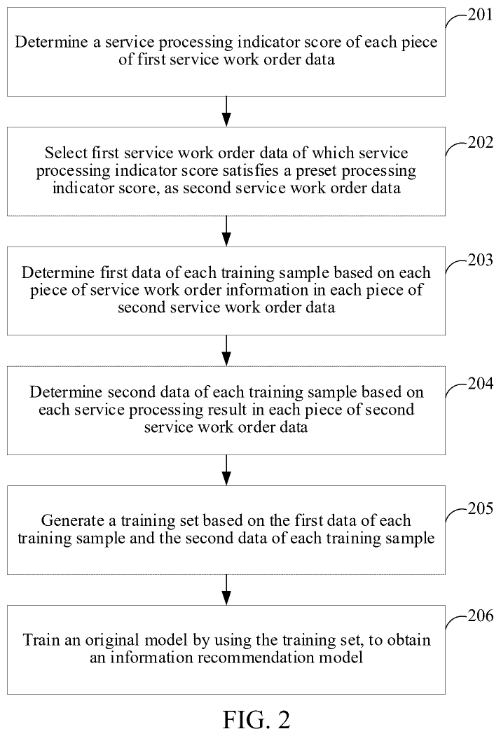

An information recommendation model training method in an aspect of this disclosure is described below. FIG. 2 is an information recommendation model training method according to an aspect of this disclosure. The method is applied to a server, and specifically includes the following operations:

Operation 201: Determine a service processing indicator score of each piece of first service work order data.

The first service work order data may be from a database, and the first service work order data may include related information of a completed service work order.

First processing conversion data, first communication data, first violation data, and first complaint data that correspond to each piece of first service work order data may be determined. A first processing indicator score corresponding to each piece of first service work order data is determined based on a first weight, and the first processing conversion data and the first communication data that correspond to each piece of first service work order data. A second processing indicator score corresponding to each piece of first service work order data is determined based on a second weight, and the first violation data and the first complaint data that correspond to each piece of first service work order data. The service processing indicator score of each piece of first service work order data is determined based on the first processing indicator score and the second processing indicator score.

Specifically, the first processing conversion data may reflect a target achievement status of the service work order, the first communication data may reflect a communication status when a customer service user processes the service work order, the first violation data may reflect a violation status when the customer service user processes the service work order, and the first complaint data may reflect a complaint status when the customer service user processes the service work order. A higher first processing indicator score indicates a higher target achievement condition of the service work order to meet a target requirement and a higher communication condition of the service work order to meet a communication requirement. A higher second processing indicator score indicates a worse violation condition of the service work order and a worse complaint condition of the service work order.

For example, in a collection scenario, the first service work order data that may be obtained includes historical collection amount data, historical communication amount data, historical effective communication data, historical communication capability data, historical communication efficiency data, historical collection conversion data, historical violation data, historical complaint data, and the like of each customer service user (that is, a candidate collection party).

In an aspect, for the historical collection amount data, a total monthly collection amount e₁ obtained through collection by the candidate collection party may be calculated. The total monthly collection amount is positively correlated to a collection capability.

In an aspect, for the historical communication amount data, an average quantity of daily calls e₂ in a current month may be calculated. To ensure stability, only calls of which call duration is greater than preset duration may be calculated. The average quantity of daily calls is positively correlated to a collection capability.

In an aspect, for the historical effective communication data, average duration of a single call e₃ in each daily segment in a current month may be calculated. Specifically, average call duration t̅₁̅ from 8 a.m. to 12 a.m. and average call duration t̅₂̅ from 14 p.m. to 20 p.m. may be determined. Then, it is set that e₃=αt̅₁+(1−α)t̅₂. α is a weight, and is 0.5 by default. To ensure stability, only calls of which call duration is greater than preset duration may be calculated. The average duration of a single call in each daily segment is positively correlated to a collection capability.

In an aspect, for the historical communication capability data, an average quantity of daily PTP e₄ in a current month may be calculated, that is, during making a call, a quantity of to-be-repaid parties who promise to pay. The average quantity of daily PTP is positively correlated to a collection capability.

In an aspect, for the historical communication efficiency data, total time of calls for successful collection t_{c} and total time of all calls tₛᵤₘ in a current month may be first calculated. Then, historical communication efficiency e₅=t_{c}/tₛᵤₘ is obtained. The historical communication efficiency is positively correlated to a collection capability.

In an aspect, for the historical collection conversion data, an average quantity of daily PTP N_{PTP} and an average quantity of daily KP N_{KP} in a current month may be calculated. A calculation formula of a historical collection conversion capability is: e₆=N_{KP}/N_{PTP}. The historical collection conversion capability is positively correlated to a collection capability.

In an aspect, for the historical violation data, a quantity of violation vocabularies or a quantity of calls in which a violation vocabulary exists of a collection party in voice-to-text data of all calls in a current month may be calculated, and is denoted as a quantity of historical violations e₇. The quantity of historical violations is negatively correlated to a collection capability.

In an aspect, for the historical complaint data, a quantity of complaints e₈ in a current month may be calculated. A quantity of historical complaints is negatively correlated to a collection capability.

Then, the collection capability is determined by using the following formulas:

$$S = {\sum }_{i}^{6} {w}_{i} {E}_{i} - {\sum }_{i}^{2} {v}_{i} {F}_{i} {\sum }_{i}^{6} {w}_{i} = 1 , and {\sum }_{i}^{2} {v}_{i} = 1.$$

S is referred to as the service processing indicator score. Eᵢ and Fᵢ are normalized indicators, and a calculation formula is:

$${E}_{i} = \frac{{e}_{i} - {e}_{i , min}}{{e}_{i , max} - {e}_{i , min}} .$$

e_{1,min} and e_{i,max} represent a minimum value and a maximum value in an i^{th} factor obtained by all collection parties in a to-be-evaluated department. wᵢ is a weight of a positive (upgrading the collection capability) indicator, and vᵢ is a weight of a negative (reducing the collection capability) indicator.

It can be learned that in this way, a processing status for the first service work order data may be determined from a plurality of dimensions, to provide data support for subsequent selection.

Operation 202: Select first service work order data of which service processing indicator score satisfies a preset processing indicator score, as second service work order data.

In an example of the foregoing collection scenario, the candidate collection party whose service processing indicator score S is greater than the preset processing indicator score may be determined as a customer service user.

In an aspect, customer service users may be divided into a plurality of levels, and a customer service user with a high level has a great collection capability. Because collection efficiency is high after a collection party with a great collection capability selects a to-be-repaid party for collection, multi-source data corresponding to the determined customer service user may be used as a training sample to train an original model. The multi-source data corresponding to the customer service user herein is the second service work order data.

It can be learned that, in this way, accurate second service work order data can be determined, to ensure that the model is trained more effectively by using a subsequently determined training sample.

Operation 203: Determine first data of each training sample based on each piece of service work order information in each piece of second service work order data.

The first data represents input data for training the original model.

Execution subject information, execution object information, execution process information, and service basic information of each second service work order may be determined based on each piece of service work order information in each piece of second service work order data. The first data of each training sample is determined based on the execution subject information, the execution object information, the execution process information, and the service basic information of each second service work order.

Because there are many data sources, the first data may be divided into first input data of each customer service user and second input data of a service user corresponding to each customer service user. The customer service user serves the service user, the customer service user is an execution subject of a service work order, and the service user is an execution object.

In an example of the collection scenario, the first input data of each customer service user may include personal basic features (gender, age, work year, group, workplace, and the like), call features (average daily call duration, average daily call start time, and the like), collection capability features (quantity of daily calls, quantity of daily promise to pay, quantity of daily achieved repayment, quantity of daily violations, quantity of complaints per month, and the like), historical dialog text features, and the like of the customer service user. This is not specifically limited herein.

The second input data of each service user may include personal basic features (for example, gender, age, education, address, native place, work year, vehicle loan/house loan, and the like), call features (average daily call duration, historical call times, and the like), service features (total loan amount, overdue amount, quantity of overdue days, quantity of contracts, maximum quantity of overdue days within three months, and quantity of complaints within three months), historical dialog text features, another derived feature (whether there are multiple loans), and the like of the service user. This is not specifically limited herein.

It can be learned that, in this way, input data for training a model can be enriched, and an effect of subsequent model training can be improved.

Operation 204: Determine second data of each training sample based on each service processing result in each piece of second service work order data.

The second data represents label data for training the original model.

The service processing result of each second service work order may be determined based on each piece of service work order information in each piece of second service work order data. The second data of each training sample is determined based on the service processing result for each second service work order. The service processing result may indicate success or unsuccess, or may indicate a specific processing progress, or the like. This is not specifically limited herein.

Operation 205: Generate a training set based on the first data of each training sample and the second data of each training sample.

It can be learned that, in this way, a training sample more effective for model training can be obtained.

Operation 206: Train the original model by using the training set, to obtain an information recommendation model.

The first data of each training sample may be inputted into the original model, to obtain a predicted probability that a service processing result of a service work order to which each training sample belongs indicates success. A first loss function is determined based on each predicted probability and the service processing result in each training sample. Reverse iteration processing is performed on the original model by using the first loss function until the original model converges, to obtain the information recommendation model.

In an aspect, after the first loss function is determined based on each predicted probability and the service processing result in each training sample, in service work order information of each training sample and when the service processing result indicates success, a first moment at which processing is performed and that corresponds to the second service work order data may be determined. In the service work order information of each training sample and when the service processing result indicates unsuccess, a second moment at which processing is performed and that corresponds to the second service work order data is determined. A second loss function is determined based on the first moment and the second moment. Reverse iteration processing is performed on the original model by using the first loss function and the second loss function until the original model converges, to obtain the information recommendation model.

The first loss function may be a cross entropy loss function, and the second loss function may be a sorting loss function.

It can be learned that, in this way, a parameter in a time dimension can be introduced, not only a service work order having a high success probability after being processed by a current customer service user can be recommended for different customer service users, but also service work orders that are more suitable for being processed in advance can be determined, thereby greatly improving intelligence and functionality of information recommendation.

In an aspect, a structure of the information recommendation model is described. The information recommendation model includes a first network module, a second network module, and an output module. The first network module is configured to extract a low-order feature, and the second network module is configured to extract a high-order feature. This is due to a problem that a large amount of feature data is missing from multi-source data, and has features of high dimensionality and high sparsity. For this type of data, focus is on learning a combined feature. The combined feature includes a second-order, a third-order, and even a higher-order feature. A higher order indicates higher complexity, and indicates that the combined feature is less easy to be learned. Both high-order and low-order combined features are very important for modeling. The output module is configured to output a probability of repayment.

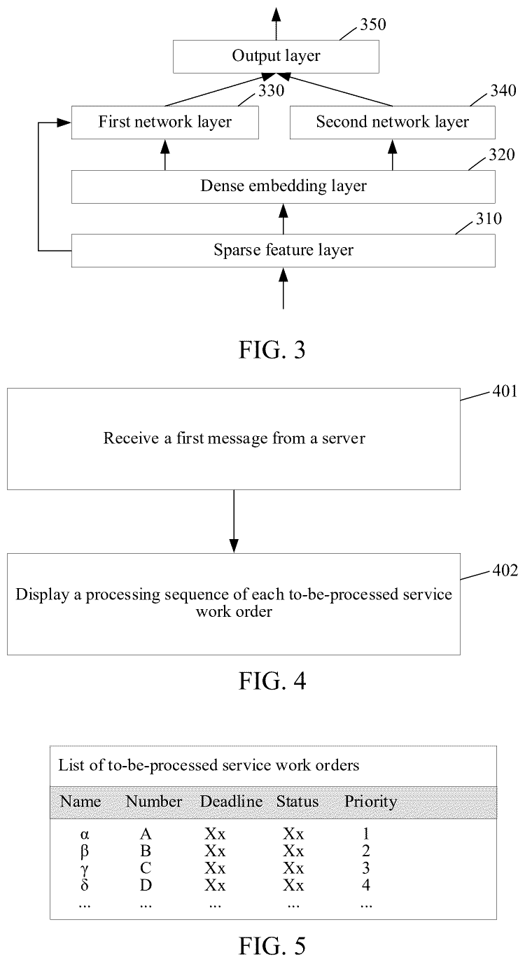

For ease of understanding, the following example describes an information recommendation model in an aspect of this disclosure with reference to FIG. 3. FIG. 3 is a schematic diagram of a structure of an information recommendation model according to an aspect of this disclosure. The information recommendation model includes a sparse feature layer 310, a dense embedding layer 320, a first network layer 330, a second network layer 340, and an output layer 350.

The sparse feature layer 310 represents concatenation of a class feature and a value feature on which one-hot encoding is performed. This is because training data includes discrete data and continuous data, the discrete data needs to be processed through one-hot conversion, and the continuous data may be first discretized and then processed through one-hot conversion.

The dense embedding layer 320 is configured to embed high-dimensional sparse input data, to obtain a low-dimensional dense vector. However, data inputted into the first network layer 330 and data inputted into the second network layer 340 are different. Unembedded data and embedded data that pass the dense embedding layer 320 may be used as input of the first network layer 330, and each dense vector may be horizontally concatenated as input of the second network layer 340. Different input data includes different features, and embedding processes are independent of each other. In this aspect of this disclosure, by default, input of the first network layer 330 and input of the second network layer 340 include the same feature, and both include all features.

The first network layer 330 may be a factorization machine, and includes a linear part and a cross part. For the linear part, a weight is assigned to each feature, and then weighted sum is performed. The linear part reflects a first-order feature. For the cross part, feature pairs are multiplied, and a weight weighted sum is assigned to the features. The cross part reflects a combined second-order feature. Then, results of the two parts are added together to form output of the first network layer 330. The unembedded data used as the input of the first network layer 330 is configured for extracting the first-order feature, and the embedded data used as the input of the first network layer 330 is configured for extracting the second-order feature.

The second network layer 340 may be a deep neural network. The input of the second network layer 340 is horizontal concatenation of all dense vectors, and output of the second network layer 340 is obtained through a plurality of hidden layers and non-linear conversion. The output is usually mapped to one dimension because the output needs to be accumulated with a result of the first network layer 330.

The output layer 350 may process, by using an activation function, data obtained by adding output data of the first network layer 330 and output data of the second network layer 340, to obtain a probability of repayment.

For example, a prediction process of the information recommendation model is described by using formulas:

$${y}_{dnn} = DNN ( Concat ( Embedding ( {x}_{dnn} ) ) ) ,$$

$${y}_{fm} = FM ( {x}_{fm} , Embedding ( {x}_{fm} ) ) , and$$

$$\hat{y} = Sigmoid ( {y}_{fm} + {y}_{fm} ) .$$

Embedding is an embedding operation, to embed high-dimensional sparse input data (vector) x_{dnn} to obtain a low-dimensional dense vector. Different input data includes different features, and embedding processes are independent of each other. Concat indicates concatenation, and each dense vector is horizontally concatenated, and is used as the input of the second network layer 340 (DNN). Original (unembedded) input x_{fm} and an embedded result thereof are used as the input of the first network layer 330 (FM), and are respectively configured for extracting the first-order feature and the second-order feature. Both x_{fm} and x_{dnn} represent input data and are allowed to include different features. In the present disclosure by default, the two pieces of data include the same features, and both include all features, that is, x_{fm} x_{dnn} x. ŷ is a probability of repayment predicted by the model.

A loss function in this aspect of this disclosure includes a first loss function, and the first loss function may be a cross entropy loss function.

Specifically, ŷ is a predicted label. Cross entropy is used as a loss function of a classification task. The classification task mainly identifies a collection for a client succeeds or fails. A calculation formula of the cross entropy is:

$${L}^{CE} = - \frac{1}{L} {\sum }_{i = 1}^{L} {\sum }_{c = 1}^{C} {y}_{i , c} \cdot log {\hat{y}}_{i , c} .$$

In the formula, y is a real label. C represents a quantity of categories, that is, C=2, and Lis a quantity of samples.

Reverse iteration processing may be performed on the original model by using the first loss function until the original model converges, to obtain a trained information recommendation model. In this way, accuracy of the information recommendation model in predicting a to-be-repaid party who is likely to repay a debt can be improved.

In an aspect, the loss function may further include a second loss function, and the second loss function may be a sorting loss function.

Specifically, the following formula is used for description:

$${L}_{pair} = \frac{1}{M} {t}_{m} / ( {t}_{m} + {t}_{n} ) - \frac{1}{N} {t}_{n} / ( {t}_{m} + {t}_{n} ) .$$

M and N respectively represent a quantity of samples predicted to repay a debt and a quantity of samples predicted to not repay a debt. tₘ and tₙ represent a sum of start time of making a call to the samples predicted to repay a debt and a sum of start time of making a call to the samples predicted to not repay a debt. The start time of making a call is an attribute of call data. The sorting loss function Lₚₐᵢᵣ is for ranking a sample that is likely to repay a debt and that is earlier in time of making a call ahead, and ranking a sample that is not likely to repay a debt and that is later in time of making a call behind. The start time of making a call herein is numeric data, and the data is not added to an input feature of the information recommendation model, but is directly introduced when the sorting loss function Lₚₐᵢᵣ is calculated. Similarly, during prediction, the start time of making a call also does not need to be used as input data.

A final loss function is a sum of a loss

$${L}_{P}^{CE}$$

of the classification task and a loss Lₚₐᵢᵣ of a sorting task:

$$L = {L}_{P}^{CE} + α {L}_{pair} .$$

In the formula, α is an adjustment parameter. The loss function is for finding a client that is likely to repay a debt and that is suitable for making a call in advance.

It can be learned that, in this way, a to-be-repaid party that is likely to repay a debt can be determined, and a to-be-repaid party that is more suitable for making a call in advance can also be determined, thereby greatly improving collection efficiency of a collection party.

Specifically, after the trained information recommendation model is obtained, the information recommendation model is made to learn data of a collection party having a great collection capability, so that a high-value client may be recommended subsequently for each level of collection party, and a low-level collection party may be selected for verification.

4K pieces of data at an E level and an F level are randomly selected as test data. In Table 1, comparison is performed on sorted Top 50% collection success rates. In Table 2, comparison is performed on real average start time corresponding to sorted Top 50% samples. Decimal conversion is performed on time in Table 2.

TABLE 1
Change of a collection success rate

| | Average collection | Test set 2K | Test set Top 50% |
|---|---|---|---|
| | success rate of | Average collection | Average collection |
| Level | full data | success rate | success rate (1K) |
| E | 75.7% | 76.1% | 90.5% |
| F | 77.0% | 77.9% | 91.1% |

TABLE 2
Change of average start time

| | Full data | Test set | Test set Top 50% |
|---|---|---|---|
| | Average start | Average start | Average start |
| Level | time (hour) | time (hour) | time (hour) |
| E | 12.06 | 11.64 | 10.79 |
| F | 11.88 | 11.24 | 10.49 |

It can be learned from Table 1 that, a to-be-repaid party that is more likely to repay a debt can be selected for a particular collection party by using the information recommendation model. In addition, it can be learned from Table 2 that, collection start time of a to-be-repaid party who is likely to pay a debt is earlier, which further proves the information recommendation model has a good ranking effect, and a to-be-repaid party who is likely to repay a debt and is suitable for making a call in advance is well founded by using the information recommendation model.

In an aspect, after the information recommendation model is obtained by training the original model through the training set, first processing may be performed on to-be-processed service work order data by using the information recommendation model, to obtain first feature data. The to-be-processed service work order data includes service work order information of each to-be-processed service work order. Second processing is performed on the to-be-processed service data by using the information recommendation model, to obtain second feature data. The first feature data and the second feature data are processed by using the information recommendation model, to obtain a probability that a service processing result for each to-be-processed service work order indicates success. A processing sequence of each to-be-processed service work order is determined based on the probability that each service processing result indicates success.

For example, in a collection scenario, different quantities of clients are dynamically allocated to different collection parties each day, in other words, different collection parties correspond to “number pools” of different clients.

First collection party data and first to-be-repaid party data may be inputted into the trained information recommendation model, and a target to-be-repaid party set is determined based on output of the trained information recommendation model. The first collection party data may include personal basic features (gender, age, work year, group, workplace, and the like), call features (average daily call duration, average daily call start time, and the like), collection capability features (quantity of daily calls, quantity of daily promise to pay, quantity of daily achieved repayment, quantity of daily violations, quantity of complaints per month, and the like), historical dialog text features, and the like of a first collection party. This is not specifically limited herein.

The first to-be-repaid party data may include personal basic features (gender, age, education, address, native place, work year, vehicle loan/house loan, and the like), call features (average daily call duration, historical call times, and the like), service features (total loan amount, overdue amount, quantity of overdue days, quantity of contracts, maximum quantity of overdue days within three months, and quantity of complaints within three months), historical dialog text features, another derived feature (whether there are multiple loans), and the like of each first to-be-repaid party. This is not specifically limited herein.

Target to-be-repaid parties in the target to-be-repaid party set are arranged according to a target sequence. A target to-be-repaid party ranked ahead indicates a higher probability of repayment after being collected by the first collection party. In an aspect, the target to-be-repaid party ranked ahead indicates earlier time suitable for collection by the first collection party. The target to-be-repaid party may be a subset of the first to-be-repaid party.

Next, target information of the target to-be-repaid party may be sent to the first collection party according to a sequence of the target sequence. The target information may include contact information, overdue duration, an overdue limit, personal information, and the like. This is not specifically limited herein. The target to-be-repaid party may be called in an automatic call manner and according to the sequence of the target sequence, or may be called manually by the first collection party. Details are not described herein again.

In an aspect, according to the information recommendation method, prediction may be performed when the “number pool” is expanded in batches. Prediction may be performed once a day, or prediction may be performed in real time. This is not specifically limited herein.

In an aspect, an unreachable number enters a “to-be-called sequence”, and re-enters the number pool after preset duration, for example, one hour.

An aspect of this disclosure further provides an information display processing method, applied to a customer service user device. FIG. 4 is a schematic flowchart of an information display processing method according to an aspect of this disclosure. The method specifically includes the following operations:

Operation 401: Receive a first message from a server.

The first message is configured for representing a processing sequence of each to-be-processed service work order of a customer service user, a representation manner for the processing sequence includes a work order sequence, the first message is determined by using an information recommendation model, and the information recommendation model is determined by the server in the following manner: determining a service processing indicator score of each piece of first service work order data; selecting first service work order data of which service processing indicator score satisfies a preset processing indicator score, as second service work order data; determining first data of each training sample based on each piece of service work order information in each piece of second service work order data; determining second data of each training sample based on each service processing result in each piece of second service work order data; generating a training set based on the first data of each training sample and the second data of each training sample; and training an original model by using the training set, to obtain the information recommendation model.

Operation 402: Display the processing sequence of each to-be-processed service work order.

Specifically, FIG. 5 is a schematic diagram of an information display interface according to an aspect of this disclosure. A to-be-processed service work order may be displayed in a sequence according to a priority. The priority herein is determined based on a processing success rate of a to-be-processed service for a customer service user. When a display manner is more intelligent, efficiency of processing a service work order by the customer service user may be improved.

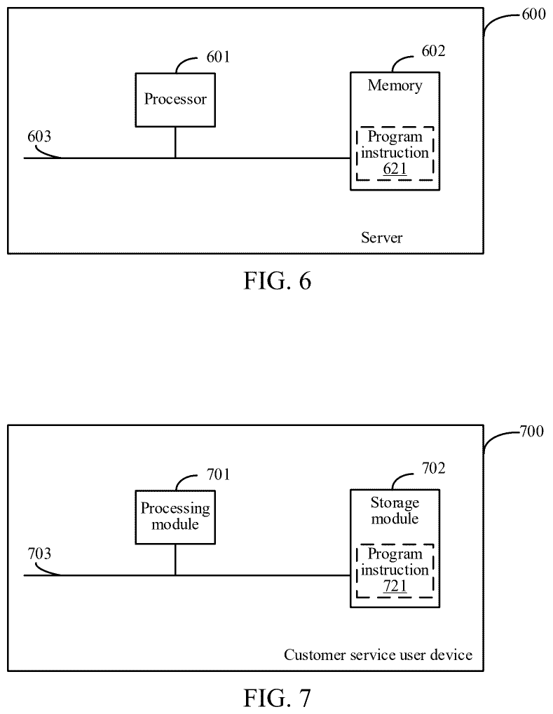

A server in an aspect of this disclosure is described below with reference to FIG. 6, which is a schematic diagram of a structure of a server according to an aspect of this disclosure. The server 600 includes a processor 601, a memory 602, and a communication bus 603 configured to connect the processor 601 and the memory 602.

The memory 602 includes, but is not limited to, a random access memory (RAM), a read-only memory (ROM), an erasable programmable read-only memory (EPROM), or a compact disc read-only memory (CD-ROM). The memory 602, such as a non-transitory computer-readable storage medium, is configured to store program code executed by and data transmitted by the server 600.

The server 600 further includes a communication interface, configured to receive and send data.

Processing circuitry, such as the processor 601 may be one or more central processing units (CPUs). When the processor 601 is one central processing unit (CPU), the central processing unit (CPU) may be a single-core central processing unit (CPU), or may be a multi-core central processing unit (CPU).

The processor 601 may be a baseband chip, a chip, a central processing unit (CPU), a general purpose processor, a DSP, an ASIC, an FPGA, or another programmable logic device, a transistor logic device, a hardware component, or any combination thereof.

The processor 601 in the server 600 is configured to execute a program instruction 621 stored in the memory 602, to perform the following operations: determining a service processing indicator score of each piece of first service work order data; selecting first service work order data of which service processing indicator score satisfies a preset processing indicator score, as second service work order data; determining first data of each training sample based on each piece of service work order information in each piece of second service work order data; determining second data of each training sample based on each service processing result in each piece of second service work order data; generating a training set based on the first data of each training sample and the second data of each training sample; and training an original model by using the training set, to obtain an information recommendation model.

According to the foregoing information recommendation model training method, information display processing method, and related apparatus, first, the service processing indicator score of each piece of first service work order data is determined; the first service work order data of which service processing indicator score satisfies the preset processing indicator score is selected, as the second service work order data; the first data of each training sample is determined based on each piece of service work order information in each piece of second service work order data; the second data of each training sample is determined based on each service processing result in each piece of second service work order data; the training set is generated based on the first data of each training sample and the second data of each training sample; and the original model is trained by using the training set, to obtain the information recommendation model. The information recommendation model can be trained by using a more effective training sample, to ensure that the information recommendation model can recommend adaptive information for different execution subjects, and facilitate improvement of intelligence and functionality of service work order allocation.

For each operation, corresponding descriptions of the foregoing method aspects may be used, and the server 600 may be configured to perform the foregoing method aspects of this disclosure. Details are not described herein again.

A customer service user device in an aspect of this disclosure is described below with reference to FIG. 7, which is a schematic diagram of a structure of a customer service user device according to an aspect of this disclosure. The customer service user device 700 includes a processing module 701, a storage module 702, and a communication bus module 703 configured to connect the processing module 701 and the storage module 702.

The storage module 702 includes, but is not limited to, a random access memory (RAM), a read-only memory (ROM), an erasable programmable read-only memory (EPROM), or a compact disc read-only memory (CD-ROM). The storage module 702 is configured to store program code executed by and data transmitted by the customer service user device 700.

The customer service user device 700 further includes a communication interface, configured to receive and send data.

The processing module 701 may be one or more central processing units (CPUs). When the processing module 701 is one central processing unit (CPU), the central processing unit (CPU) may be a single-core central processing unit (CPU), or may be a multi-core central processing unit (CPU).

The processing module 701 may be a baseband chip, a chip, a central processing unit (CPU), a general purpose processor, a DSP, an ASIC, an FPGA, or another programmable logic device, a transistor logic device, a hardware component, or any combination thereof.

The processing module 701 in the customer service user device 700 is configured to execute a program instruction 721 stored in the storage module 702, to perform the following operations: receiving a first message from a server, the first message being configured for representing a processing sequence of each to-be-processed service work order of a customer service user, a representation manner for the processing sequence including a work order sequence, the first message being determined by using an information recommendation model, and the information recommendation model being determined by the server in the following manner: determining a service processing indicator score of each piece of first service work order data; selecting first service work order data of which service processing indicator score satisfies a preset processing indicator score, as second service work order data; determining first data of each training sample based on each piece of service work order information in each piece of second service work order data; determining second data of each training sample based on each service processing result in each piece of second service work order data; generating a training set based on the first data of each training sample and the second data of each training sample; and training an original model by using the training set, to obtain the information recommendation model; and displaying the processing sequence of each to-be-processed service work order.

According to the foregoing information recommendation model training method, information display processing method, and related apparatus, first, the service processing indicator score of each piece of first service work order data is determined; the first service work order data of which service processing indicator score satisfies the preset processing indicator score is selected, as the second service work order data; the first data of each training sample is determined based on each piece of service work order information in each piece of second service work order data; the second data of each training sample is determined based on each service processing result in each piece of second service work order data; the training set is generated based on the first data of each training sample and the second data of each training sample; and the original model is trained by using the training set, to obtain the information recommendation model. The information recommendation model can be trained by using a more effective training sample, to ensure that the information recommendation model can recommend adaptive information for different execution subjects, and facilitate improvement of intelligence and functionality of service work order allocation.

For each operation, corresponding descriptions of the foregoing method aspects may be used, and the customer service user device 700 may be configured to perform the foregoing method aspects of this disclosure. Details are not described herein again.

The foregoing describes the solutions in aspects of this disclosure mainly from the perspective of an execution process on a method side. To implement the foregoing functions, an electronic device includes a corresponding hardware structure and/or software module for performing the functions. A person skilled in the art may easily be aware that, in this disclosure, the units and algorithm operations described with reference to aspects disclosed in this specification may be implemented by hardware or a combination of hardware and computer software. Whether a function is performed by hardware or computer software driving software depends on applications and design constraint conditions of the technical solutions.

In aspects of this disclosure, functional units of the electronic device may be divided according to the foregoing method examples. For example, functional units may be divided for corresponding functions, or two or more functions may be integrated into one processing unit. The integrated unit may be implemented in the form of hardware, or may be implemented in the form of a software functional unit. In aspects of this disclosure, division into the units is an example, and is merely a logical function division.

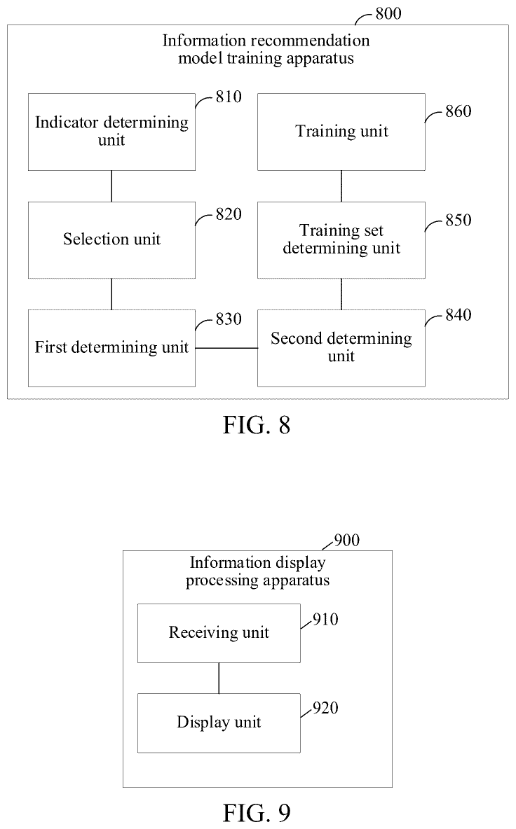

In a case in which the functional modules are divided based on corresponding functions, FIG. 8 is a block diagram of formation of functional units of an information recommendation model training apparatus according to an aspect of this disclosure, applied to a server. The information recommendation model training apparatus 800 includes:
an indicator determining unit 810, configured to determine a service processing indicator score of each piece of first service work order data;
a selection unit 820, configured to select first service work order data of which service processing indicator score satisfies a preset processing indicator score, as second service work order data; and
a first determining unit 830, configured to determine first data of each training sample based on each piece of service work order information in each piece of second service work order data;
a second determining unit 840, configured to determine second data of each training sample based on each service processing result in each piece of second service work order data;
a training set determining unit 850, configured to generate a training set based on the first data of each training sample and the second data of each training sample; and
a training unit 860, configured to train an original model by using the training set, to obtain an information recommendation model.

According to the foregoing information recommendation model training method and related apparatus, first, the service processing indicator score of each piece of first service work order data is determined; the first service work order data of which service processing indicator score satisfies the preset processing indicator score is selected, as the second service work order data; the first data of each training sample is determined based on each piece of service work order information in each piece of second service work order data; the second data of each training sample is determined based on each service processing result in each piece of second service work order data; the training set is generated based on the first data of each training sample and the second data of each training sample; and the original model is trained by using the training set, to obtain the information recommendation model. The information recommendation model can be trained by using a more effective training sample, to ensure that the information recommendation model can recommend adaptive information for different execution subjects, and facilitate improvement of intelligence and functionality of service work order allocation.

For each operation, corresponding descriptions of the foregoing method aspects may be used, and the information recommendation model training apparatus 800 may be configured to perform the foregoing method aspects of this disclosure. Details are not described herein again.

In a case in which the functional modules are divided based on corresponding functions, FIG. 9 is a block diagram of formation of functional units of an information display processing apparatus according to an aspect of this disclosure, applied to a customer service user device. The information display processing apparatus 900 includes:
a receiving unit 910, configured to receive a first message from a server, the first message being configured for representing a processing sequence of each to-be-processed service work order of a customer service user, a representation manner for the processing sequence including a work order sequence, the first message being determined by using an information recommendation model, and the information recommendation model being determined by the server in the following manner: determining a service processing indicator score of each piece of first service work order data; selecting first service work order data of which service processing indicator score satisfies a preset processing indicator score, as second service work order data; determining first data of each training sample based on each piece of service work order information in each piece of second service work order data; determining second data of each training sample based on each service processing result in each piece of second service work order data; generating a training set based on the first data of each training sample and the second data of each training sample; and training an original model by using the training set, to obtain the information recommendation model; and
a display unit 920, configured to display the processing sequence of each to-be-processed service work order.

According to the foregoing information recommendation model training method, information display processing method, and related apparatus, first, the service processing indicator score of each piece of first service work order data is determined; the first service work order data of which service processing indicator score satisfies the preset processing indicator score is selected, as the second service work order data; the first data of each training sample is determined based on each piece of service work order information in each piece of second service work order data; the second data of each training sample is determined based on each service processing result in each piece of second service work order data; the training set is generated based on the first data of each training sample and the second data of each training sample; and the original model is trained by using the training set, to obtain the information recommendation model. The information recommendation model can be trained by using a more effective training sample, to ensure that the information recommendation model can recommend adaptive information for different execution subjects, and facilitate improvement of intelligence and functionality of service work order allocation.

For each operation, corresponding descriptions of the foregoing method aspects may be used, and the information display processing apparatus 900 may be configured to perform the foregoing method aspects of this disclosure. Details are not described herein again.

An aspect of this disclosure further provides a chip, including a processor, a memory, and a computer program or instructions stored on the memory. The processor executes the computer program or instructions to perform the operations described in the foregoing method aspects.

An aspect of this disclosure further provides a chip module, including a transceiver component and a chip. The chip includes a processor, a memory, and a computer program or instructions stored on the memory. The processor executes the computer program or instructions to perform the operations described in the foregoing method aspects.

An aspect of this disclosure further provides a computer storage medium. The computer storage medium stores a computer program configured for data exchange, the computer program enables a computer to perform some or all of the operations of any method described in the foregoing method aspects, and the computer includes an electronic device.

An aspect of this disclosure further provides a computer program product. The computer program product includes a non-transitory computer-readable storage medium storing a computer program. The computer program is operable to enable a computer to execute some or all of the operations of any method described in the method aspects. The computer program product may be a software installation package, and the computer includes an electronic device.

For ease of description, the foregoing aspects are described as a series of action combinations. A person skilled in the art is to be know that, this disclosure is not limited to the described sequence of the actions because some operations may be performed in another sequence or performed at the same time according to aspects of this disclosure. In addition, a person skilled in the art is also to be know that, aspects described in this specification are examples, and the involved actions, operations, modules, or units are not necessarily required in aspects of this disclosure.

In the foregoing aspects, the descriptions have respective focuses in aspects of this disclosure. For a part that is not described in detail in an aspect, reference can be made to related descriptions in other aspects.

The operations of the method or algorithm described in aspects of this disclosure may be implemented in hardware, or by a processor executing software instructions. The software instruction may include a corresponding software module, and the software module may be stored in a RAM, a flash memory, a ROM, an EPROM, an electrically erasable programmable read-only memory (EEPROM), a register, a hard disk drive, a removable hard disk, a compact disc read-only memory (CD-ROM), or any storage medium of other forms well-known in the art. For example, a storage medium is coupled to a processor, so that the processor can read information from the storage medium or write information into the storage medium. Certainly, the storage medium may alternatively be a component of the processor. The processor and the storage medium may be located in the ASIC. In addition, the ASIC may be located in a terminal device or a management device. Certainly, the processor and the storage medium may be used as discrete assemblies existing in a terminal device or a management device.

A person skilled in the art is to be aware that in the one or more examples, the functions described in aspects of this disclosure may be implemented by hardware, software, firmware, or any combination thereof. When software is used, all or some of examples may be in the form of a computer program product. The computer program product includes one or more computer instructions. When the computer program instructions are loaded and executed on a computer, all or some of the processes or functions according to aspects of this disclosure are generated. The computer may be a general-purpose computer, a dedicated computer, a computer network, or another programmable apparatus. The computer instructions may be stored in a computer-readable signal medium, or transmitted from one computer-readable storage medium to another computer-readable storage medium. For example, the computer instruction may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any available medium that can be accessed by the computer, or a data storage device such as a server or a data center, integrating one or more usable media. The usable medium may be a magnetic medium (for example, a floppy disk, a hard disk drive, or a magnetic tape), an optical medium (for example, a digital video disc (DVD)), a semiconductor medium (for example, a solid-state disk (SSD)), or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing further describe the objectives, technical solutions, and beneficial effects of aspects of this disclosure, but are not intended to limit the scope of this disclosure. Modification, equivalent replacement, or improvement made based on aspects of this disclosure fall within the scope of aspects of this disclosure.

What is claimed is:

1. An information recommendation method, the method comprising:
determining a service processing indicator score of each service work order of a first set of service work orders;
selecting, from the first set of service work orders, a second set of service work orders with service processing indicator scores that satisfy a preset value;
determining first data of each of the second set of service work orders based on service work order information in each of the second set of service work orders;
determining second data of each of the second set of service work orders based on a service processing result in each of the second set of service work orders;
generating a training set based on the first data and the second data;
training an initial information recommendation model based on the training set, to obtain an information recommendation model;
obtaining a processing sequence of each of a plurality of to-be-processed service work orders based on the information recommendation model; and
displaying the processing sequence of the plurality of to-be-processed service work orders.

2. The method according to claim 1, wherein the determining the service processing indicator score further comprises:
determining a first processing indicator score of each service work order of the first set of service work orders based on first processing conversion data, first communication data, and a first weight, the first processing conversion data and the first communication data corresponding to each of the first set of service work orders;
determining a second processing indicator score of each service work order of the first set of service work orders based on first violation data, first complaint data, and a second weight, the first violation data and the first complaint data corresponding to each of the first set of service work orders; and
determining the service processing indicator score of each service work order based on the first processing indicator score of the respective service work order and the second processing indicator score of the respective service work order.

3. The method according to claim 1, wherein the service work order information comprises:
execution subject information, execution object information, execution process information, and service basic information.

4. The method according to claim 3, wherein the first data includes input data for training the initial information recommendation model, and the second data includes label data for training the initial information recommendation model.

5. The method according to claim 1, wherein the training the initial information recommendation model further comprises:
inputting the first data into the initial information recommendation model, to obtain a service processing result indicating success of a service work order;
determining a first loss function based on the service processing result in each of the second set of service work orders; and
performing reverse iteration processing on the initial information recommendation model based on the first loss function until the initial information recommendation model converges, to obtain the information recommendation model.

6. The method according to claim 5, wherein the method further comprises:
determining first timing information when the service processing result indicates success;
determining second timing information when the service processing result indicates unsuccess;
determining a second loss function based on the first timing information and the second timing information; and
performing reverse iteration processing on the initial information recommendation model by using the first loss function and the second loss function until the initial information recommendation model converges, to obtain the information recommendation model.

7. The method according to claim 1, wherein the method further comprises:
for each of the plurality of to-be-processed service work orders,
performing first processing on the respective to-be-processed service work order based on the information recommendation model, to obtain first feature data;
performing second processing on the respective to-be-processed service work order based on the information recommendation model, to obtain second feature data;
processing the first feature data and the second feature data based on the information recommendation model, to obtain a probability that a service processing result for the respective to-be-processed service work order indicates success; and
determining the processing sequence of the plurality of to-be-processed service work orders based on the probability that each of the plurality of service processing results indicates success.

8. An information recommendation apparatus, the apparatus comprising:
processing circuitry configured to
determine a service processing indicator score of each service work order of a first set of service work orders;
select, from the first set of service work orders, a second set of service work orders with service processing indicator scores that satisfy a preset value;
determine first data of each of the second set of service work orders based on service work order information in each of the second set of service work orders;
determine second data of each of the second set of service work orders based on a service processing result in each of the second set of service work orders;
generate a training set based on the first data and the second data;
train an initial information recommendation model based on the training set, to obtain an information recommendation model;
obtain a processing sequence of each of a plurality of to-be-processed service work orders based on the information recommendation model; and
display the processing sequence of the plurality of to-be-processed service work orders.

9. The apparatus according to claim 8, wherein the processing circuitry is configured to:
determine a first processing indicator score of each service work order of the first set of service work orders based on first processing conversion data, first communication data, and a first weight, the first processing conversion data and the first communication data corresponding to each of the first set of service work orders;
determine a second processing indicator score of each service work order of the first set of service work orders based on first violation data, first complaint data, and a second weight, the first violation data and the first complaint data corresponding to each of the first set of service work orders; and
determine the service processing indicator score of each service work order based on the first processing indicator score of the respective service work order and the second processing indicator score of the respective service work order.

10. The apparatus according to claim 8, wherein the service work order information comprises:
execution subject information, execution object information, execution process information, and service basic information.

11. The apparatus according to claim 10, wherein the first data includes input data for training the initial information recommendation model, and the second data includes label data for training the initial information recommendation model.

12. The apparatus according to claim 8, wherein the processing circuitry is configured to:
input the first data into the initial information recommendation model, to obtain a service processing result indicating success of a service work order;
determine a first loss function based on the service processing result in each of the second set of service work orders; and
perform reverse iteration processing on the initial information recommendation model based on the first loss function until the initial information recommendation model converges, to obtain the information recommendation model.

13. The apparatus according to claim 12, wherein the processing circuitry is configured to:
determine first timing information when the service processing result indicates success;
determine second timing information when the service processing result indicates unsuccess;
determine a second loss function based on the first timing information and the second timing information; and
perform reverse iteration processing on the initial information recommendation model by using the first loss function and the second loss function until the initial information recommendation model converges, to obtain the information recommendation model.

14. The apparatus according to claim 8, wherein the processing circuitry is configured to:
for each of the plurality of to-be-processed service work orders,
perform first processing on the respective to-be-processed service work order based on the information recommendation model, to obtain first feature data;
perform second processing on the respective to-be-processed service work order based on the information recommendation model, to obtain second feature data;
process the first feature data and the second feature data based on the information recommendation model, to obtain a probability that a service processing result for the respective to-be-processed service work order indicates success; and
determine the processing sequence of the plurality of to-be-processed service work orders based on the probability that each of the plurality of service processing results indicates success.

15. A non-transitory computer-readable storage medium, storing instructions which when executed by a processor cause the processor to perform:
determining a service processing indicator score of each service work order of a first set of service work orders;
selecting, from the first set of service work orders, a second set of service work orders with service processing indicator scores that satisfy a preset value;
determining first data of each of the second set of service work orders based on service work order information in each of the second set of service work orders;
determining second data of each of the second set of service work orders based on a service processing result in each of the second set of service work orders;
generating a training set based on the first data and the second data;
training an initial information recommendation model based on the training set, to obtain an information recommendation model;
obtaining a processing sequence of each of a plurality of to-be-processed service work orders based on the information recommendation model; and
displaying the processing sequence of the plurality of to-be-processed service work orders.

16. The non-transitory computer-readable storage medium according to claim 15, wherein the determining the service processing indicator score further comprises:
determining a first processing indicator score of each service work order of the first set of service work orders based on first processing conversion data, first communication data, and a first weight, the first processing conversion data and the first communication data corresponding to each of the first set of service work orders;
determining a second processing indicator score of each service work order of the first set of service work orders based on first violation data, first complaint data, and a second weight, the first violation data and the first complaint data corresponding to each of the first set of service work orders; and
determining the service processing indicator score of each service work order based on the first processing indicator score of the respective service work order and the second processing indicator score of the respective service work order.

17. The non-transitory computer-readable storage medium according to claim 15, wherein the service work order information comprises:
execution subject information, execution object information, execution process information, and service basic information.

18. The non-transitory computer-readable storage medium according to claim 17, wherein the first data includes input data for training the initial information recommendation model, and the second data includes label data for training the initial information recommendation model.

19. The non-transitory computer-readable storage medium according to claim 15, wherein the training the initial information recommendation model further comprises:
inputting the first data into the initial information recommendation model, to obtain a service processing result indicating success of a service work order;
determining a first loss function based on the service processing result in each of the second set of service work orders; and
performing reverse iteration processing on the initial information recommendation model based on the first loss function until the initial information recommendation model converges, to obtain the information recommendation model.

20. The non-transitory computer-readable storage medium according to claim 19, storing instructions which when executed by the processor further cause the processor to perform:
determining first timing information when the service processing result indicates success;
determining second timing information when the service processing result indicates unsuccess;
determining a second loss function based on the first timing information and the second timing information; and
performing reverse iteration processing on the initial information recommendation model by using the first loss function and the second loss function until the initial information recommendation model converges, to obtain the information recommendation model.
